(19) United States
(12) Patent Application Publication
(10) Pub. No.: US 2009/0169277 A1
(43) Pub. Date: Jul. 2, 2009

(54) ON-DEMAND PRINT FINISHING SYSTEM USING SURFACE DETECTION AND REPLICATION

(76) Inventors: William Y. Fowlkes, Pittsford, NY (US); Joseph A. Manico, Rochester, NY (US); Angelo Caruso, Rochester, NY (US)

Correspondence Address: David A. Novais;Patent Legal Staff, Eastman Kodak Company, 343 State Street, Rochester, NY, 14650-2201, US

(21) Appl. No.: 11/964,966

(22) Filed: Dec. 27, 2007

(51) Int. Cl. G03G 15/20

(52) U.S. Cl. 399/341; 399/342

(57) ABSTRACT

An on-demand printing system and more specifically to a printing system that includes both scanner and printer functionality in one integrated unit. The printing system further including both image and gloss detection devices in the one integrated unit as well as a finishing system that is capable of printing with some specified level of gloss in one or more areas of the final product.

### FIELD OF THE INVENTION

This invention relates in general to a printing system and more specifically to a printing system that includes both scanner and printer functionality in one integrated unit. The printing system further includes a finishing system that is capable of printing with some specified level of gloss in one or more areas of the final product.

### BACKGROUND OF THE INVENTION

Printing, such as electrophotography (EP), has become more and more capable of reproducing pictorial subject matter, especially in three or four colors in addition to a clear toner so that now users often desire to print textural material, graphics and/or pictorial subject matter. Users of office copiers have an increasing demand for a combination of text and photo quality images in one print. Users are also demanding results similar to those achieved by professional print shops. Professional print shops produce documents such as brochures, certificates, pamphlets, and the like with spot gloss or spot vanish. This treatment can be a regional or image-wise coating of clear ink or toner.

In addition new printers have scanners associated with them to enhance functionality. These All-in -One printers have created the need for on-demand finishing functionality along with the development of a more energy efficient, quicker starting, lower cost, and more reliable fusing processes, that can deliver both quality text and proper image quality.

To meet the proper image quality in today's market, control of the image gloss, luster and other surface finishes has become more important. The ability to match the media surface gloss for all image color densities as closely as possible, determines the level of image quality with respect to the fusing process. A user selectable gloss level and coverage is also needed to satisfy end user demands. The differences between high (glossy) photo quality gloss, medium graphic arts quality gloss, and low (matte) text quality gloss are large and have been unattainable using prior art printers and current printing methods.

This is especially apparent when printing a combination of text and pictorial subject matter. Many of the images that combine the text and pictorial subject matter would benefit from a new printing system since the combination causes a problem when, for instance, the user prefers a more matte finish for the text but not for pictorial subject matter where the user desires a gloss finish. There is a need to change the final finish options on the fly as the user and/or document requires. This is not possible with current printers that do not have the ability to determine finish requirements on the fly on area-by-area basis.

A solution has been found to this problem. Using a gloss detection device in combination with the image scanning system, information about the original document's gloss level as well as the image content can be conveyed to the printing system. The printing system can then use its gloss producing capability to reproduce the gloss appearance as well as the image content resulting in a much higher fidelity copy of the original.

### SUMMARY OF THE INVENTION

This invention is directed to a method of forming a gloss-matched multicolor image using an electrographic printer (EP) by matching an original finish by detecting an original finish having reflective characteristics with or without an image and the forming an area by area multicolor toner image on a receiver using a printer, such as an EP printer, with toners of at least three different colors of toner which form various combinations of colors at different pixel locations on the receiver to form the multicolor toner image thereon using a generic color profile to form a clear toner overcoat upon the multicolor toner image using EP based on the characteristics of said original finish.

It is an object of the invention to provide a method of producing toner images having portions of varying texture or gloss. This and other objects are accomplished by determining or defining a portion of an image that is to be of a different gloss or texture than the rest of the image and producing a toner image on a receiving sheet which toner image includes a gloss or texture varying toner selectively positioned in the defined or determined portion.

According to one embodiment, an operator of a printer or a copier determines which portion of an image the operator wishes to have at a higher gloss, for example, a color pictorial portion. The location of that pictorial portion is input to the copier or printer, which creates an image of a gloss enhancing toner corresponding to that portion. That particular image is superposed on the rest of the toner image or images thereby producing an image having a gloss that varies at least according to the presence of the gloss producing toner image. With this method the operator can decide to make glossy a color pictorial portion of an image and leave as a matte finish, text or graphics, whatever the color of the text or graphics.

According to another embodiment an image may be analyzed electronically utilizing known characteristics that differentiate a pictorial portion from a graphic or alphanumeric portion. Utilizing that information, a gloss or texture varying toner can be applied selectively to automatically gloss the pictorial portion of the image while leaving unglossed the text or graphics. Alternately, a gloss enhancing toner can be applied imagewise in the pictorial portion of the image to even the gloss and height of the image in the pictorial region while leaving the text of graphics with a more textured finish. It may even be advantageous to apply glossy transparent toner to a low density region or in the form of an inverse mask of a pictorial halftone so that differential gloss between a high density and low density region can be reduced. Another advantage of selective application of transparent glossing toner is that it does not necessarily increase the toner fusing mass to be higher than that of a regular four-color image.

### BRIEF DESCRIPTION OF THE DRAWINGS

FIG. 1: All-in-One, multifunction printer

FIG. 2: Printer with finishing system(s) for gloss control

FIG. 3: Prior Art Scanner

FIG. 4: Scanner with gloss detection system

FIG. 5: Block diagram of gloss reproduction system

FIG. 6: Gloss detection device

FIG. 7: Block diagram of gloss detection unit

FIG. 8: Examples of gloss detection results

FIG. 9: Block diagram of MFP system with gloss reproduction capability

### DETAILED DESCRIPTION OF THE INVENTION

The invention has been described in detail with particular reference to certain preferred embodiments thereof but it will be understood that variations and modifications can be effected within the spirit and scope of the invention.

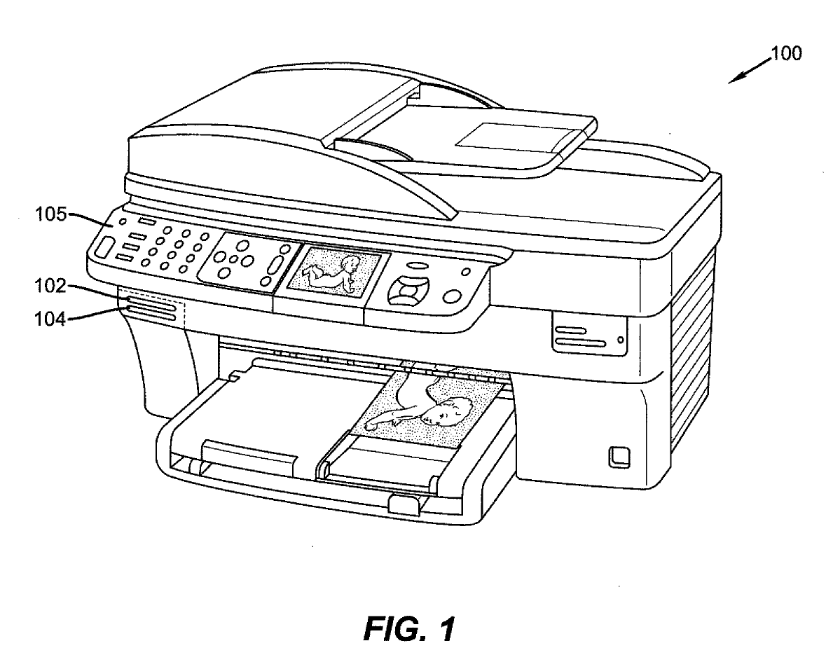

FIG. 1 shows the on-demand printing system 100, such as an all-in-one printer, including an image detection device 102 and a gloss detection device 104. Such an all-in-one printer and scanner would be similar to an “All-In-One” product such as the Eastman Kodak Series (5500), which provides integrated printing, faxing, scanning and copying functions, all in color. The printer/scanner system includes a circuit card with firmware 105 (shown with dashed lines). Algorithms utilized by the printing system, including the image detection device 102 and the gloss detection device 104 controls, can be stored in the firmware 105. It should be understood that other system configurations can be employed. The on-demand printing system 100 includes scanning functionality and equipment as well as printer functionality and equipment in one integrated unit. Such integration can be physical, where the scanner and printer hardware are mechanically attached to each other. Or, it can be a virtual integration where the scanning unit and the printer unit are logically attached by wires, a network, or wireless network, and software.

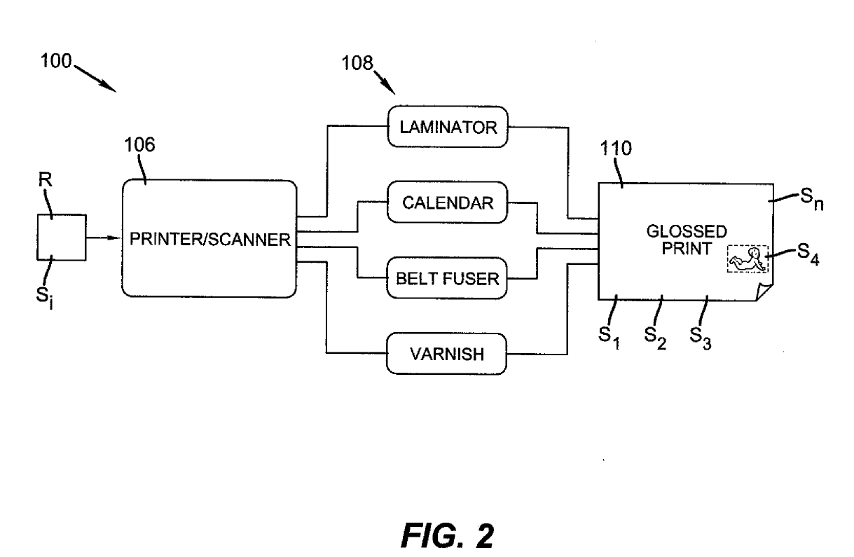

FIG. 2 shows on-demand printing system 100 with finishing capabilities, including printing with some specified level of gloss. Those skilled in the art understand that there are many means of achieving a specified level of gloss including, but not limited to, overcoats or varnishes applied after printing, calendaring or reflowing toner in a ferrotyping step after printing, laminating a clear overcoat with a particular gloss level and finishing the print in such as way that the gloss matches a desired gloss level. In the on-demand printing system a receiver R enters the printer 106 having a surface Si. The receiver may be an unprinted receiver, such as plain paper, or may already have print such as text or pictorial images. The finishing device 106 can use a variety of methods to finish the receiver after printing, as described above, to produce a surface S1,2,3,4,n on print 110.

Professional print shops produce documents, such as brochures, certificates, pamphlets, and the like with spot gloss or spot varnish. This treatment can be a regional or image-wise coating of clear ink or toner. Clear ink or toner can also be printed as a watermark such as a single or repeating phrase of logo that is barely visible on the document and appears as a an area or pattern of increased gloss relative to the unprinted area of the document as described in U.S. Pat. No. 7,228,006 entitled Method and system for detecting a geometrically transformed copy of an image and U.S. Pat. No. 6,888,647 entitled Proofing with watermark information created by a raster imaging processor. With the advent of a 5th station and clear toner in on-demand printing systems such as the Kodak NexPress 2500, it is now possible to add digitally addressable spot gloss to individual documents.

The on-demand printing system described below is a system using a specially modified document scanner to scan a document. The modified document scanner is adapted to record areas and/or patterns of regional gloss by causing these gloss areas and/or patterns to produce a higher level of glare (e.g. illuminating light source reflecting back in nearly perpendicular to the recording device) than the surrounding areas and to reproduce, along with a duplicate of the original image information, matching gloss areas and/or patterns. A linear array or area array scanner using polarizing filter in conjunction with a conventional light source can be used to obtain a conventional image scan from an original document. A secondary “glare scan” can be obtained with the polarizing filter removed from the scanner and illuminated by a repositioned conventional light source or by a secondary on-axis light source. Once both, conventional scan and glare scan digital images are captured, the image data from both is be compared to identify the glare or high gloss patterns. These patterns are then converted to an additional printing channel to apply a clear spot gloss overcoat in registration with the image channels of 3 (RGB) or 4 (CMYK) color image.

An alternative approach is to use a conventional scanner to determine if the original document has areas that are appropriate to receive regional gloss areas and/or patterns. This is accomplished by identifying the content object types (text, graphics, and/or image) in a scanned document using image analysis, object recognition (rectangular photo), face recognition, and other techniques such as OCR to determining candidate content object types for spot gloss. Once candidate object types are identified, spot gloss patterns are derived from candidate content objects such as; reverse mask for image content including image outline shape, area overcoat for graphics matching the shapes of graphic items, and no spot gloss for text. Once the candidate object types have been determined to be suitable for gloss, a spot gloss overlay is created from patterns derived from the candidate object types in registration with image channels (RGB or CMYK) of the copied original document. This capability can be provided as both an automatic; “provide spot gloss” feature and/or “user edit spot gloss” with a UI (User Interface) and/or GUI (Graphic User Interface) depicting a representation of the document with a visual indication of the spot gloss placement on the document.

Multi function printers (MFP) discussed in this description, also referred to as all-in-one printers, include both scanning and printing functionality and equipment in one integrated unit. The integrated printer and scanning functionality can be physical, such that the printing systems the scanner and printer hardware are mechanically attached to each other. Alternatively the printing system can be integrated using a virtual integration where the scanning unit and the printer unit are logically attached by wires, or a wireless network, a network and software. The scanning function is carried out by transporting a sheet of paper or other original document past a detection device than can read a line of information in synchronization with the movement of the sheet so as to produce a data file containing a representation of the image content of the original. This can be repeated for each sheet in a multi-sheet document by the use of an automatic document feeder (ADF).

The marking engine of the MFP system can be toner or ink jet based. One type of marking engine is an electrophotographic (EP) printer that uses EP toner. Toner is meant to include many types of marking materials including pigmented toner and dye based toners as well as other toner with and without a color. Typically, the image data file is processed by an image writing unit and printed onto receiver sheets that are picked by a paper handing unit, sometimes referred to as a paper picking unit, from a tray in the MFP all under control of a Central Control Unit [CCU]. In most MEP systems such printing is done with no regard for the gloss characteristics of the original or the receiver sheets resulting in copies of the original that do not reproduce the gloss level of the original.

In such systems featuring a scanner and printer, a major application is the copying of documents. This is done by first scanning the document using the scanning function. This may be a single page scan, usually done using a flat bed scanner or a multi-page scan, usually done using an automated document feeder (ADF). Then the scanned document is converted into digital data that can be used to produce a replica of the original document. Such copies are limited today to replicate the image content information. Other qualities of the original, such as the gloss of the original document, are not reproduced. This results in customer dissatisfaction because image gloss is an important component of the overall document's appearance.

Various solutions exist in the printing industry for controlling the gloss level of the printed output. There are many means of achieving a specified level of gloss available, as represented in FIG. 2, to those skilled in the art including the application of overcoats or varnishes applied during finishing. Typically these are liquid solutions that dry to a clear, shiny layer, providing a high level of gloss. By the use of different solutions, the level of gloss can be controlled. Another approach to producing gloss is calendaring or reflowing toner in a ferrotyping step, such as by the use of a belt fuser, after printing. In this approach, which is limited to marking particles such as toner that have well defined visco-elastic properties, the image toner is given a smooth upper surface that results in a controllable level of gloss. Such an approach will only affect the gloss of the toned region, but by applying clear toner are the non-toned regions, as described in prior art U.S. Pat. No. 5,234,783 entitled Method of selectively glossing toner images. Also described in U.S. Pat. No. 7,239,816 entitled Automated image appearance control method and Method and U.S. Pat. No. 7,236,734 entitled Apparatus for electrostatographic printing with enhanced color gamut, a uniform gloss level can be achieved. Laminating a clear overcoat with a particular gloss level can also be used to result in a controlled gloss level. All of these techniques (and others not discussed) can be used to finishing the print in such as way that the gloss matches the gloss level of the receiver, or to change the gloss to a desired level.

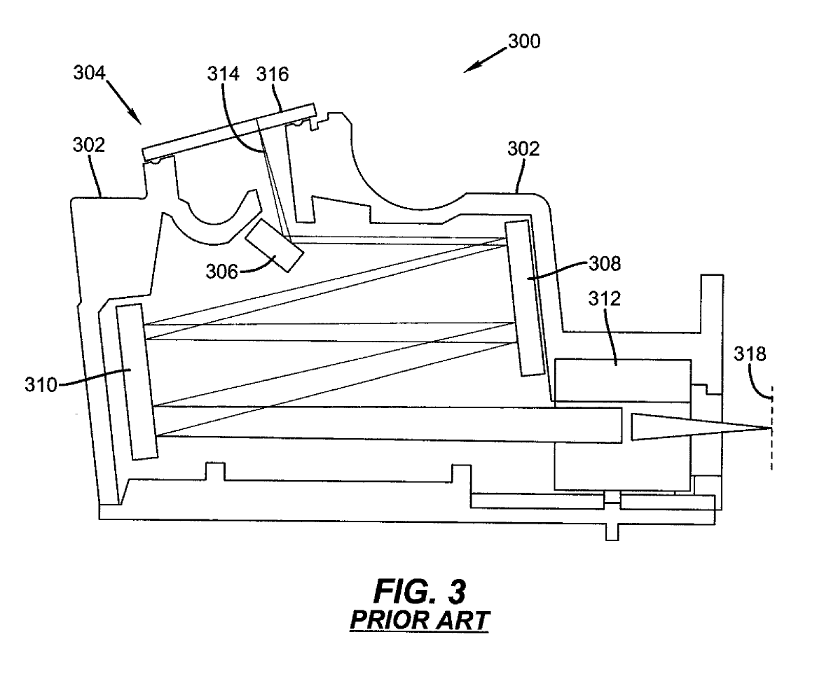

The image scanning device of a various printers can use illumination and detection to read the density levels in an image wise fashion on the original. In one prior art printer 300, shown in FIG. 3, a scanning laser beam 314 is used to read the original one pixel at a time. Scanning devices or systems typically include an array of optical sensor elements and a scan area (e.g., plate of glass) where an object to be imaged by the sensor elements is positioned. An optical path including, for example, lenses and mirrors, spans between the sensor elements and the scan area. Referring to FIG. 3, a conventional scanner 150 includes a main housing 302, a glass plate 304, mirrors 306, 308, 310 and a lens 312 configured as shown. An optical path 314 of the scanner 300 begins at an object focal plane 316 at the top surface of the glass plate 304, reflects from the mirrors 306, 308, 310 as shown, and passes through the lens 312 to end at the sensor focal plane 318 (shown with a dashed line). Other scanners employ a light bar and a linear array of detectors. With such a system there is no way to detect or measure the gloss level of the original and therefore no way to provide the information necessary to reproduce the gloss level of the original document.

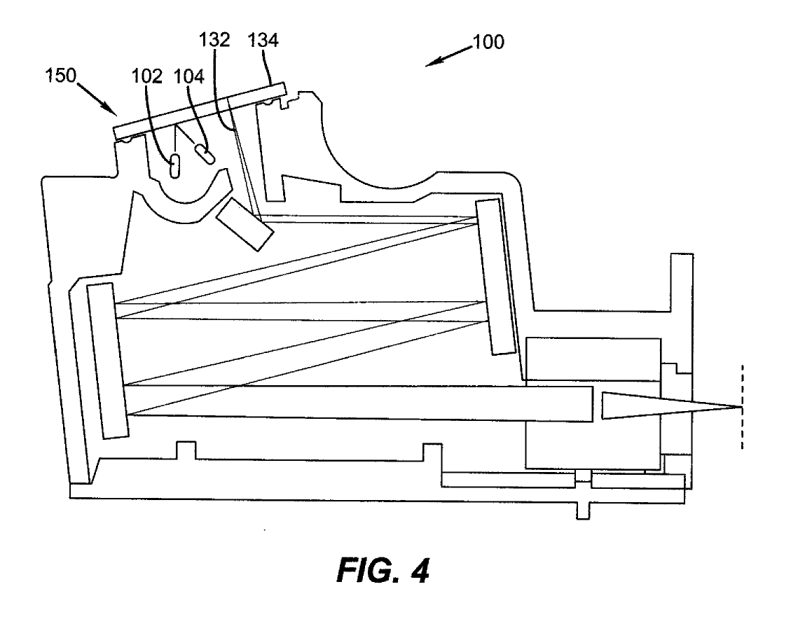

FIG. 4 shows an embodiment of the on-demand printing system 100 which includes a modified scanning system 150 that also provides, in addition to the image detection 102, a gloss detection device 104 that functions to allow the scanner to read the gloss level of the original document. This gloss detection would be made essentially simultaneously to the image detection as described below.

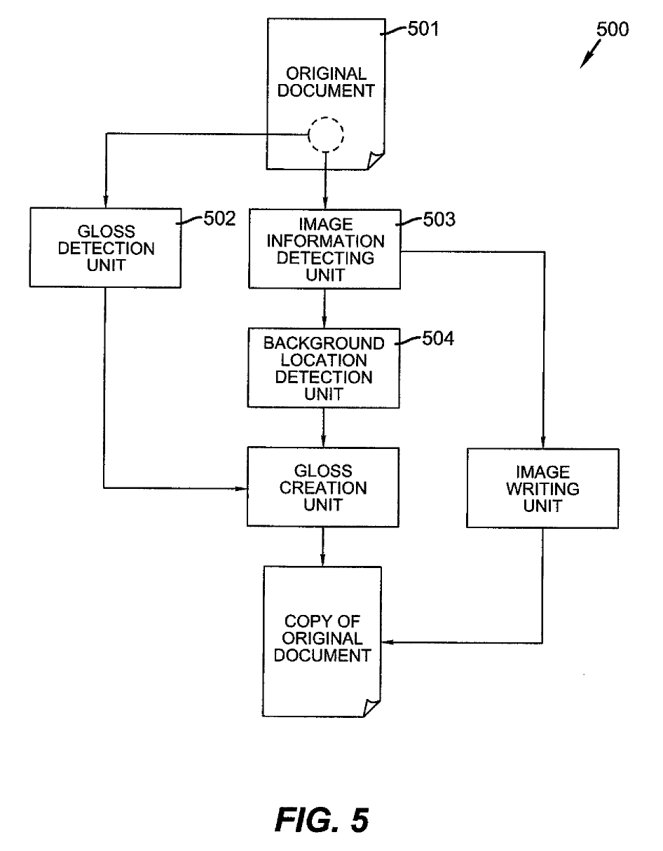

FIG. 5 shows a block diagram of a gloss reproduction system 500 that can detect and reproduce the gloss and image content of an original document 501. As proposed in this invention, the gloss detection unit 502 and the image detection unit 503 will work simultaneously, detecting both gloss and density information from the document 501. The gloss detection unit will read information essentially from one location that will scan down the document. The image scanning unit will read across and down the document so as to detect the entire image. For the application described herein, it is necessary to detecting the gloss level of the original document. That can be done in the image areas, but such as measurement is made more difficult by the presence of the toned image and may not be representative of the over all gloss level. Better is the detect the gloss level in the untoned regions, also referred to as the Background locations of the original document. As described in more detail below, the simultaneous detection of the gloss level and image content by the respective units 502 and 503 allows the background location unit 504 to recognize which gloss readings correspond to the background location. This information is then used by the gloss creation unit 505 and the image writing unit 506 to create a copy of the original document that can reproduce gloss and well as image content.

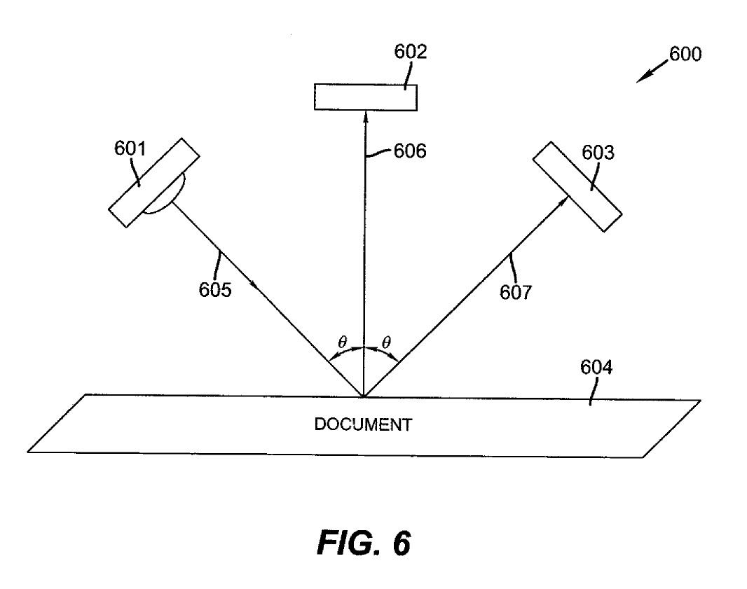

FIG. 6 shows the details of the gloss detection unit 600. Such a device feature a collimated light source 601 and two detectors. The light source directs a light beam 605 that is directed at the surface of a document 604. The light from the incident beam is scattered 606 and specularly reflected 607. One detector 602 is positioned so as to receive the scattered light. Another detector is position so as to receive the specularly reflected light. High gloss surface will have predominately reflected light, so the specular light intensity Int₆₀₇>>Int₆₀₆, where Int₆₀₆ is the intensity of the light scattered into detector 602 and Int₆₀₇ is the intensity of the light reflected into detector 603. Low gloss surfaces have more scattered light so that Int₆₀₆>>Int₆₀₇.

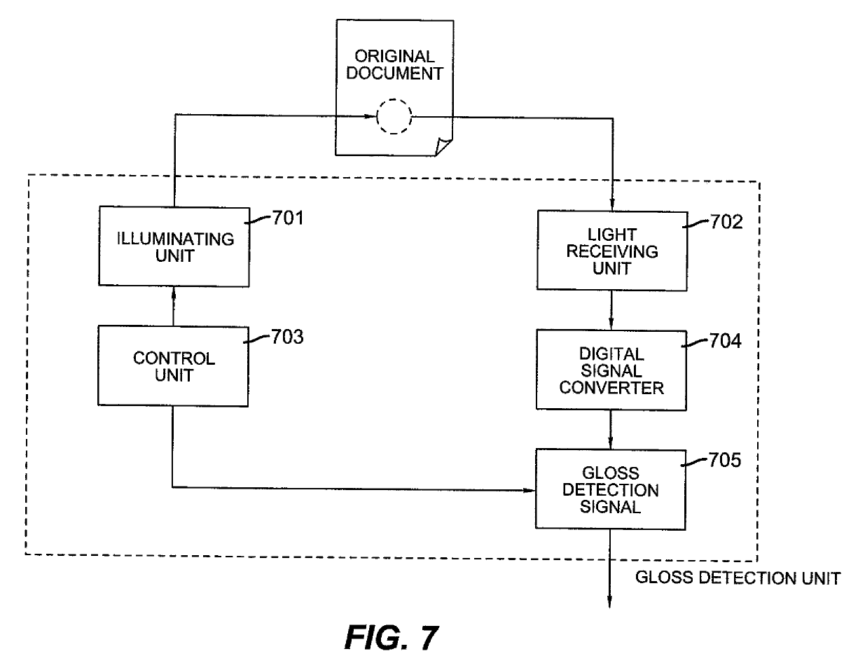

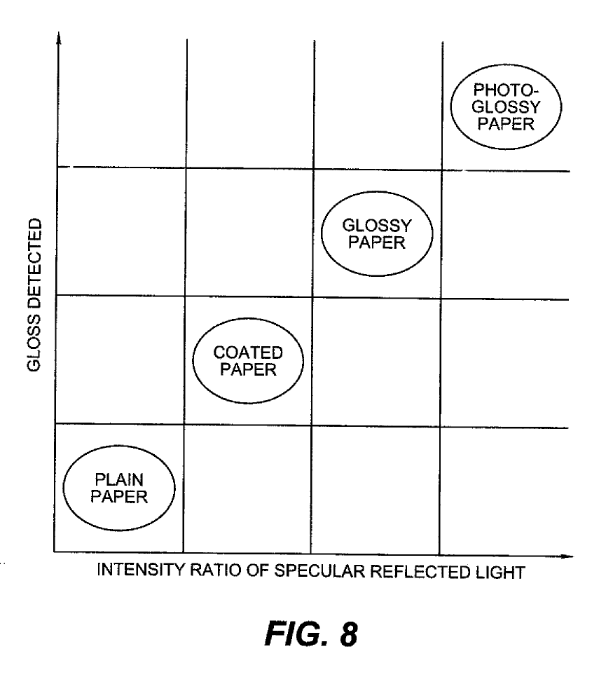

FIG. 7 shows a more detailed block diagram of the gloss detection unit. The gloss detection unit operates under the control of the scanner control unit 704. Under the direction of the scanner control unit, the two intensity readings, Int₆₀₇ and Int₆₀₆, detected in the background areas are averaged. The light receiving unit 702, which includes both detectors 602 and 603, provides the detector signals to the digital signal converter 704. The signal converter digitizes the ratio of the intensity readings from the two detectors. Thus, the ratio Int₆₀₇/Int₆₀₆ forms is the signal that is a function of the gloss level. FIG. 8 shows some examples of different gloss levels and how the signal will vary as a function of gloss level.

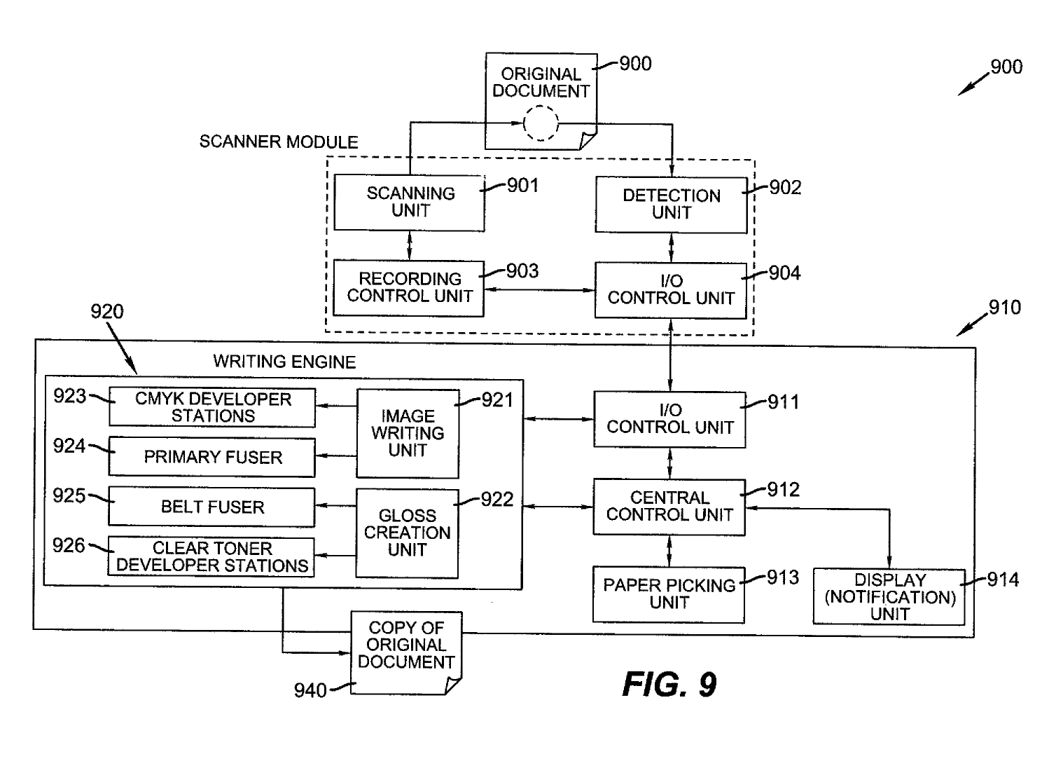

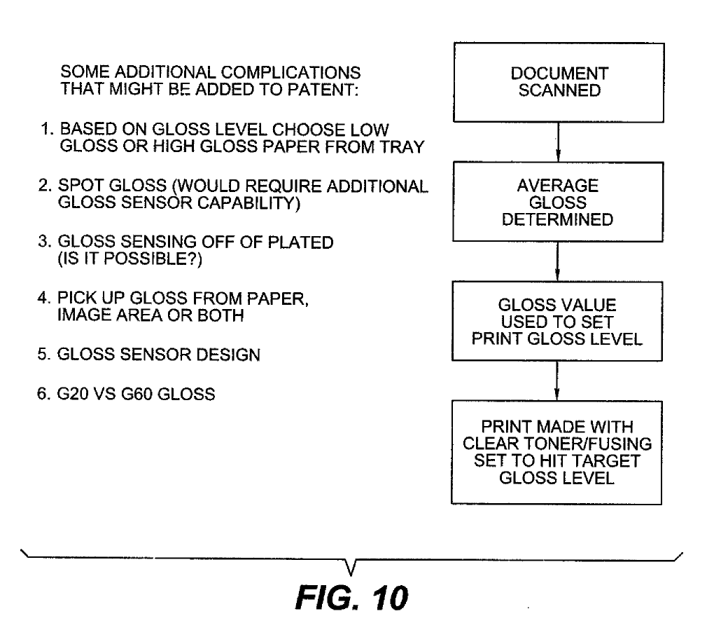

One embodiment of the proposed invention is for an MFP with an electrophotographic (EP) writing engine that features clear toner and a combination of a primary fuser and a belt fuser, as described in prior art U.S. Pat. No. 7,236,734 and 2006/0285890 which are incorporated by reference and discuss a system capable of produce gloss output of a specified level. FIG. 9 shows a block diagram of such a printing system. This system is made up of a scanner module 900 and a printer module 910, which contains a writing engine 920. The scanner module would have a scanning unit 901 and detecting unit 902 that operate under the control of the scanner control unit. The scanning and detection units are capable of detecting the image and detecting the gloss level of the original document 930. Under the direction of the Scanner control unit, the average gloss level detected in the background areas and the complete image density data file are communicated to the scanner I/O control unit 904. The scanner I/O unit 904 and the printer I/O control unit 911 transfer the image and gloss data to the printer module 910.

Within the printer module a central control unit 912 coordinates and controls the operations of the I/O control unit 911, paper picking 913 and transport, information display 914, and the writing engine 920. The image data information is transferred to the image writing unit 921 which controls the EP cycle for the Cyan, Magenta, Yellow and Black cartridges and the primary fuser 924. The image writing unit writes the CMYK records onto the receiver sheet in a manner well understood by those skilled in the art. The gloss creation unit 922 controls the application of the clear toner 926 and secondary belt fuser 925 that together produce the desired gloss level to match the original. The combined actions of the image writing unit and the gloss unit 921 and 922 results in the out put of a copy 940 that reproduces the image content and the gloss level of the original 930.

The invention has been described in detail with particular reference to certain preferred embodiments thereof, but it will be understood that variations and modifications can be effected within the spirit and scope of the invention. This invention is inclusive of combinations of the embodiments described herein. References to a “particular embodiment” and the like refer to features that are present in at least one embodiment of the invention. Separate references to “am embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like are not limiting

1. A method of forming a gloss-matched multicolor image using an electrographic printer (EP) by matching an original finish comprising:
detecting an original finish of a document to be copied comprising original image information and secondary information comprising two or more areas of regional gloss to be reproduced;
forming a multicolor toner image on a receiver using toners of at least three different colors of toner which form various combinations of colors at different pixel locations on the receiver to form the multicolor toner image thereon using a generic color profile based on the original image information;
comparing the to be copied document areas of regional gloss to the original image information; and
forming a clear toner overcoat upon the multicolor toner image based on the characteristics of said original finish including areas of regional gloss.

2. The method according to claim 1 wherein said detecting step further comprises detecting the gloss differential of both said toner image and receiver sequentially.

3. The method according to claim 1 wherein said forming a clear toner overcoat step further comprises forming on a spot by spot basis to form a spot gloss finish.

4. The method according to claim 1 wherein both said detecting and said forming steps further comprise detecting and forming on a pixel by pixel level.

5. The method according to claim 1 wherein both said detecting and said forming steps further comprise detecting and forming a predetermined gloss during the printing process based on measured gloss levels of an original unprinted receiver.

6. The method according to claim 1 wherein said detecting and forming steps are further controlled by the same controller for forming said image and forming said overcoat.

7. The method according to claim 1 wherein said forming a clear toner overcoat step further comprises controlling said generic color profile based on receiver type.

8. The method according to claim 1 wherein said forming a clear toner overcoat step further comprises forming the clear overcoat in one or more areas to reproduce a finish of an original receiver.

9. The method according to claim 8 further comprising rescaling said clear toner overcoat in coordination with the rescaling of the multicolor image on said receiver.

10. The method according to claim 1 wherein said detecting step further comprises comparing two image scans, one of which utilizes polarized light.

11. The method according to claim 1 wherein said detecting step further comprises an illumination source from an image scanner to detect said original finish.

12. The method according to claim 1 wherein said step of forming a clear toner overcoat further comprises detecting the original finish utilizing a densitometer to give one or more density readings of the original receiver.

13. A computer program stored in a computer-readable medium for causing a computer to execute the method according to claim 1.

14. A computer program stored in a computer-readable medium for causing a computer to execute the method according to claim 12.

15. A system for forming a multicolor image having a finish matching an original finish comprising:
a detector for detecting an original finish having reflective characteristics adapted to record an original image information and secondary information comprising two or more areas of regional gloss;
a printhead for forming a multicolor toner image on a receiver with toners of at least three different colors of toner which form various combinations of colors at different pixel locations on the receiver to form the multicolor toner image thereon using a generic color profile; based on the original image information; and an overcoat applicator for applying a clear toner overcoat upon the multicolor toner image based on the characteristics of said original finish including areas of regional gloss.

16. The system according to claim 15 wherein the overcoat applicator applies said clear toner overcoat using said generic color profile wherein said generic color profile is based on receiver type.

17. The system according to claim 15 wherein said detector further comprises an image detection and a gloss detection device for detecting the gloss differential of both said toner image and receiver.

18. The system according to claim 15 wherein said overcoat applicator further comprises an image detection and a gloss detection device forming said overcoat on a spot by spot basis to form a spot gloss finish.

19. The system according to claim 15 wherein said overcoat applicator applies said overcoat based on a table of a predetermined gloss of one or more receivers based on measured gloss levels.

20. The system according to claim 15 wherein said overcoat applicator comprises forming said overcoat in one or more shapes at one or more locations, so that one or more original finishes are resealed in coordination with the rescaling of said multicolor image on said receiver.

21. The system according to claim 15 wherein said detector further comprises a gloss meter.

22. The system according to claim 15 further comprising an illumination source from an image scanner to detect said original finish.

23. The system according to claim 15 wherein said detector further comprises an image scanner.

24. A method of forming a gloss-matched multicolor image using an electrographic printer (EP) by matching an original finish comprising:
detecting an original finish having reflective characteristics of both a toner and a media together comprising original image information and secondary information comprising two or more areas of regional gloss;
forming a multicolor toner image on a receiver using toners of at least three different colors of toner which form various combinations of colors at different pixel locations on the receiver to form the multicolor toner image thereon using a generic color profile based on the original image information; and forming a clear toner overcoat upon the multicolor toner image based on the characteristics of said original finish on a spot by spot basis to form a spot gloss finish.

25. The method according to claim 24 wherein said detector and said overcoat applicator further comprise the same controller for image laydown and the glosser.
